(19) United States
(12) Patent Application Publication
(10) Pub. No.: US 2011/0217939 A1
(43) Pub. Date: Sep. 8, 2011

(54) INFORMATION PROCESSING APPARATUS AND ANTENNA FREQUENCY CONTROL METHOD

(75) Inventors: Toshiyuki Hirota, Hino-shi (JP); Masao Teshima, Kunitachi-shi (JP); Anwar Sathath, Ome-shi (JP); Takeshi Tajima, Ome-shi (JP)

(73) Assignee: KABUSHIKI KAISHA TOSHIBA, Tokyo (JP)

(21) Appl. No.: 13/042,036

(22) Filed: Mar. 7, 2011

(30) Foreign Application Priority Data
Mar. 5, 2010 (JP) 2010-049915

(51) Int. Cl. H04B 1/04

(52) U.S. Cl. 455/123

(57) ABSTRACT

According to one embodiment, an information processing apparatus includes an antenna, a switch circuit, a wireless communication module and a resonance frequency controller. The switch circuit is configured to switch a resonance frequency band of the antenna between a first resonance frequency band and a second resonance frequency band. The wireless communication module is configured to execute wireless communication by use of the first resonance frequency band and wireless communication by use of the second resonance frequency band. The resonance frequency controller is configured to control the switch circuit in order to set the resonance frequency band of the antenna to one of the first resonance frequency band and the second resonance frequency band based on status information indicating an execution state of wireless communication by use of the wireless communication module. The resonance frequency controller acquires the status information from the wireless communication module.

### CROSS-REFERENCE TO RELATED APPLICATIONS

This application is based upon and claims the benefit of priority from Japanese Patent Application No. 2010-049915, filed Mar. 5, 2010, the entire contents of which are incorporated herein by reference.

### FIELD

Embodiments described herein relate generally to an antenna frequency control technique suitably used for a personal computer or the like including a wireless communication function, for example.

### BACKGROUND

Recently, various mobile personal computers such as notebook computers have been developed. Most of the above types of mobile personal computers include wireless communication functions to perform wireless communications with an external device such as a server on Internet in a mobile environment, for example. Further, recently, it is required for the wireless communication functions of the mobile personal computers to support a plurality of wireless communication systems with an increase in the number of types of wireless communication systems.

In Jpn. Pat. Appln. KOKAI Publication No. 2004-23768, a wireless communication system is disclosed in which a mobile terminal can make an adequate Internet connection according to a location where it exists by including a mechanism of transmitting the fact that it lies within an access point (AP) service area of a wireless local area network (WLAN) system to the mobile terminal via a cell station (CS) of a wireless wide area network (WWAN). Specifically, the wireless communication system is not required to always monitor whether the terminal lies within the AP service area of the WLAN system on the mobile terminal side. Further, it is possible to make an Internet connection by use of the WWAN system in the CS service area of the WWAN system except the AP service area of the WLAN system and make an Internet connection by use of the WLAN system in the AP service area of the WLAN system. As a result, power saving of the mobile terminal can be attained.

For example, it is assumed that the mobile terminal of the wireless communication system disclosed in Jpn. Pat. Appln. KOKAI Publication No. 2004-23768 includes an antenna including a function of switching resonance frequency bands. In this case, for example, it seems general to consider that a wireless communication module which actually controls the wireless communication by use of the antenna may be designed to include a function of actually controlling switching of the resonance frequency bands of the antenna in order to adequately shift a state in which an Internet connection is made by use of the WWAN system to a state in which an Internet connection is made by use of the WLAN system.

However, if a function is additionally given to the wireless communication module, for example, there occurs a problem of a cost increase.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary perspective view showing the appearance of an information processing apparatus of a first embodiment.

FIG. 2 is an exemplary block diagram showing the system configuration of the information processing apparatus of the first embodiment.

FIG. 3 is an exemplary diagram showing the frequency characteristic of an antenna provided in the information processing apparatus of the first embodiment.

FIG. 4 is an exemplary diagram for illustrating the operation principle of the antenna frequency control operation performed by the information processing apparatus of the first embodiment.

FIG. 5 is an exemplary flowchart for illustrating the operation procedure of the antenna frequency control operation performed by the information processing apparatus of the first embodiment.

FIG. 6 is an exemplary diagram for illustrating the operation principle of the antenna frequency control operation performed by an information processing apparatus of a second embodiment.

FIG. 7 is an exemplary diagram for illustrating the operation principle of the antenna frequency control operation performed by an information processing apparatus of a third embodiment.

### DETAILED DESCRIPTION

Various embodiments will be described hereinafter with reference to the accompanying drawings.

In general, according to one embodiment, an information processing apparatus includes an antenna, a switch circuit, a wireless communication module and a resonance frequency controller. The switch circuit is configured to switch a resonance frequency band of the antenna between a first resonance frequency band and a second resonance frequency band. The wireless communication module is configured to execute wireless communication by use of the first resonance frequency band and wireless communication by use of the second resonance frequency band. The resonance frequency controller is configured to control the switch circuit in order to set the resonance frequency band of the antenna to one of the first resonance frequency band and the second resonance frequency band based on status information indicating an execution state of wireless communication by use of the wireless communication module. The resonance frequency controller acquires the status information from the wireless communication module.

### First Embodiment

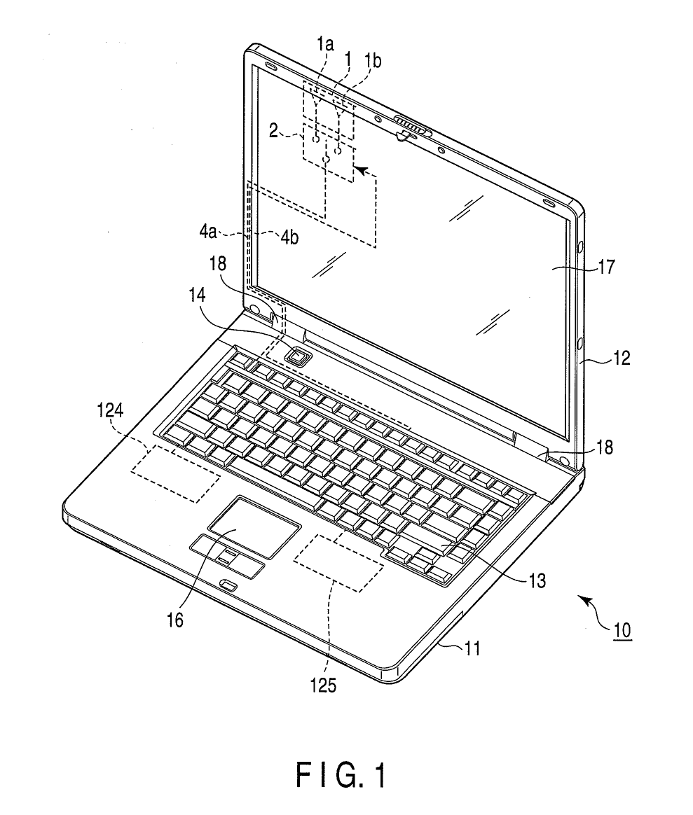

FIG. 1 shows the appearance of an information processing apparatus of a first embodiment. The information processing apparatus is realized as a mobile personal computer 10 that can be battery-driven.

FIG. 1 is an exemplary perspective view showing a state in which the display unit of the computer 10 is opened. The computer 10 is configured to include a computer main body 11 and display unit 12. In the display unit 12, a display device configured by a liquid crystal display (LCD) 17 is incorporated and the display screen of the LCD 17 is positioned in substantially the central portion of the display unit 12.

The display unit 12 is mounted to freely rotate on the computer main body 11 via hinge portions 18. The hinge portions 18 are coupling portions that couple the display unit 12 to the computer main body 11. That is, the display unit 12 is supported by use of the hinge portions 18 arranged at the rear end portions of the computer main body 11. The display unit 12 is mounted to freely rotate on the computer main body 11 by use of the hinge portions 18 between an open position in which the upper surface of the computer main body 11 is exposed and a closed position in which the upper surface of the computer main body 11 is covered with the display unit 12.

In the inner portion of the display unit 12, an antenna 1 and a switch circuit 2 are provided. The antenna 1 and switch circuit 2 may function as a reconfigurable antenna that can change the resonance frequencies. That is, the antenna 1 has at least two of first and second resonance frequency bands and the switch circuit 2 functions as a frequency switch that switches the resonance frequency bands of the antenna 1 between the first and second resonance frequency bands.

Specifically, the antenna 1 includes an antenna element 1a that covers the first resonance frequency band and an antenna element 1b that covers the second resonance frequency band and the switch circuit 2 switches the connection destination of a signal line 4a lead out from a wireless communication module 124 provided in the main body 11 into the display unit 12 via the hinge portions 18 between the antenna elements 1a and 1b. The switch circuit 2 switches the antenna elements according to a control signal supplied via a signal line 4b lead out from the internal portion of the main body 11 into the display unit 12 via the hinge portions 18. The computer 10 has a mechanism of separately performing the control operation of the switch circuit 2 via the signal line 4b by use of an embedded controller/keyboard controller (EC/KBC) 125 which is provided in the main body 11 as will be described later without using the wireless communication module 124 that outputs a transmission signal to the antenna 1. Thus, it becomes unnecessary to additionally provide a function (a function of changing the antenna resonance frequencies) to the wireless communication module 124. This point is described in detail below.

In this case, an example in which the antenna 1 includes the antenna element 1a that covers the first resonance frequency band and the antenna element 1b that covers the second resonance frequency band is shown. However, the antenna 1 may be configured to include an antenna element that exclusively and selectively covers one of the first and second resonance frequency bands. In this case, for example, the resonance frequency band of the antenna 1 is changed between the first and second resonance frequency bands by changing the constants of components of a capacitor (L) or a condenser (C) in the antenna element connected to the ground (GND) by use of the switch circuit 2. For example, the first resonance frequency band may be selected in a period in which the switch 2 is set in an off state and the second resonance frequency band may be selected in a period in which the switch 2 is set in an on state by a control signal. Further, the antenna 1 and switch circuit 2 may be mounted on the same substrate.

The computer main body 11 is a base unit having a thin box-shaped casing and a keyboard 13, a power button 14 which turns on/off the power source of the computer 10, a touchpad 16 and the like are arranged on the upper surface thereof. Further, in the internal portion of the computer main body 11, a system board (also called a motherboard) on which various electronic components are mounted is provided. On the system board, the wireless communication module 124 and EC/KBC 125 that are described before are provided.

The wireless communication module 124 is a module that performs wireless communications with the external device according to a third-generation mobile communication system (3G), for example. In the third-generation mobile communication system (3G), for example, an 850-MHz band (824 to 894 MHz) or 900-MHz band (880 to 960 MHz) is used. The 850-MHz band is used in, for example, the United States, Japan and the like and the 900-MHz band is used in, for example, Europe. In this case, it is assumed that the first resonance frequency band is set to the 850-MHz band and the second resonance frequency band is set to the 900-MHz band. That is, in this example, it is assumed that the wireless communication module 124 is a 3G wireless communication module.

For example, the mounting position of the antenna 1 is the upper end portion in the display unit 12. The wireless communication module 124 can perform wireless communications with the external device in a state in which the antenna 1 is arranged in a relatively high position by mounting the antenna 1 on the upper end portion in the display unit 12.

For example, the signal line 4a is configured by a cable such as a coaxial cable and the cable is passed through a space in the internal portion of the hinge portion 18. Likewise, the signal line 4b is configured by a cable and the cable is passed through a space in the internal portion of the hinge portion 18. The cables are lead out from the computer main body 11 to the display unit 12 via the hinge portions 18.

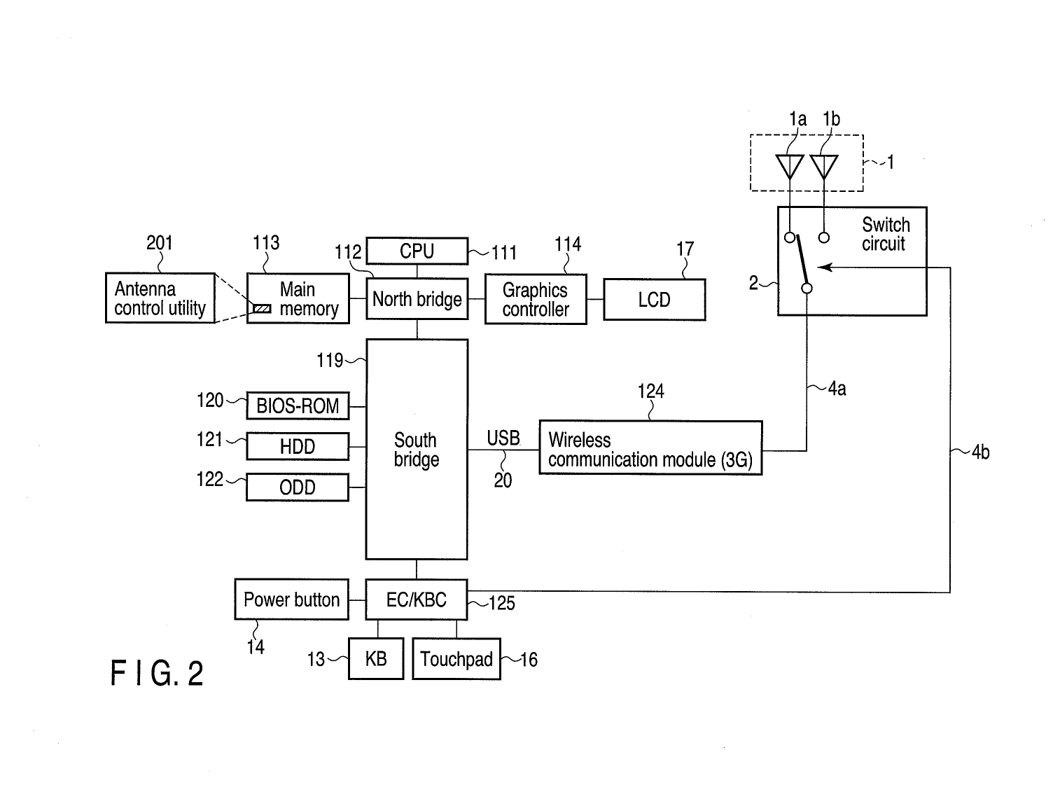

Next, the system configuration of the computer 10 is explained with reference to FIG. 2.

As shown in FIG. 2, the computer 10 includes a CPU 111, north bridge 112, main memory 113, graphics controller 114, south bridge 119, Basic Input/Output System read-only memory (BIOS ROM) 120, hard disk drive (HDD) 121, optical disc drive (ODD) 122, wireless communication module 124, EC/KBC 125 and the like.

The CPU 111 is a processor that controls the operation of the computer 10 and executes various programs loaded from the HDD 121 and ODD 122 to the main memory 113. Various programs include an operating system (OS) that performs resource management, utility programs and application programs executed under OS control, and an antenna control utility 201 which will be described later exists as one of the above programs. Further, the CPU 111 executes a BIOS stored in the BIOS-ROM 120. The BIOS is a program that controls hardware. In the following description, the BIOS itself stored in the BIOS-ROM 120 may be expressed by a BIOS 120.

The north bridge 112 is a bridge device that connects the local bus of the CPU 111 to the south bridge 119. The north bridge 112 includes a function of performing communication with the graphics controller 114 via an accelerated graphics port (AGP) bus.

The graphics controller 114 is a display controller that controls the LCD 17 used as a display monitor of the computer 10. The south bridge 119 is a bridge device that controls various I/O devices. The south bridge 119 is connected to the wireless communication module 124 via a bus 20 such as a Universal Serial Bus (USB), for example.

The wireless communication module 124 includes an antenna terminal used for transmitting and receiving a radio frequency (RF) signal. The antenna terminal of the wireless communication module 124 is connected to the antenna 1 via a signal line 4a configured by a cable such as a coaxial cable (via the switch circuit 2).

The EC/KBC 125 is a one-chip microcomputer in which a built-in controller for power management and a keyboard controller used for controlling the keyboard (KB) 13 and touchpad 16 are integrated. The EC/KBC includes a function of turning on/off the power source of the computer 10 according to the operation of the power button 14. The EC/KBC 125 is connected to the switch circuit 2 via the signal line 4b.

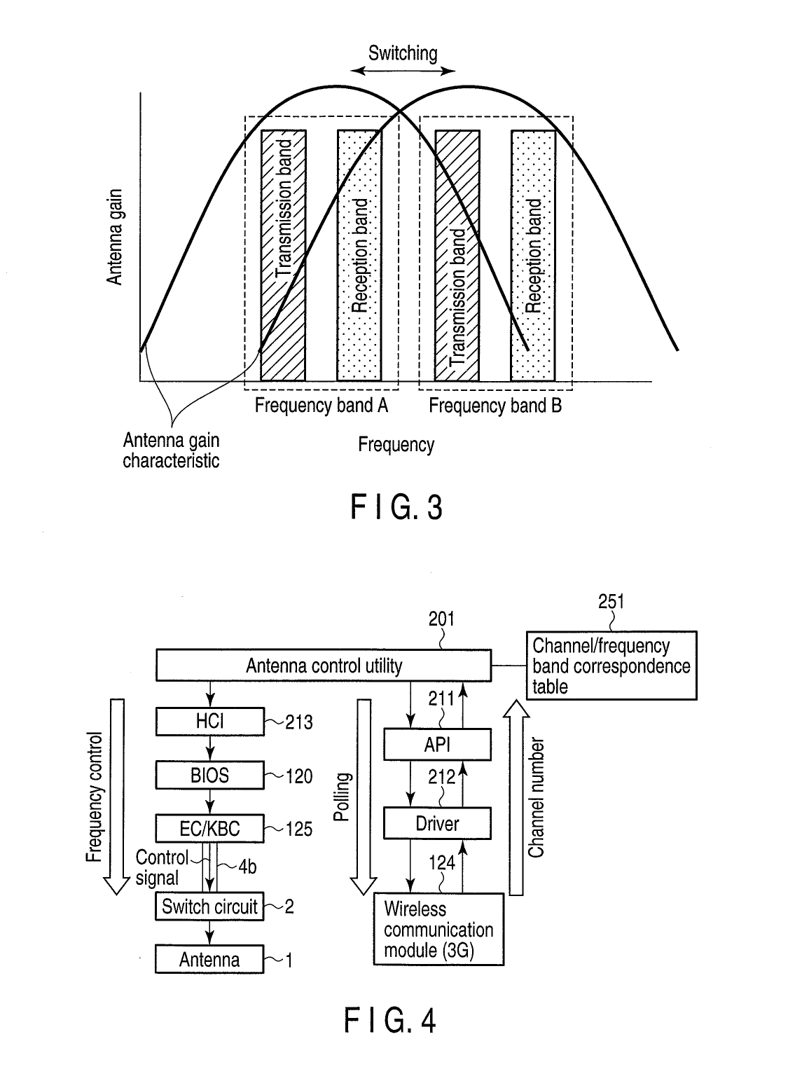

FIG. 3 is an exemplary diagram showing an example of two resonance frequency bands provided in the antenna 1. As described before, the antenna 1 includes the first resonance frequency band that is the 850-MHz band and the second resonance frequency band that is the 900-MHz band. Frequency band A shown in FIG. 3 corresponds to the first resonance frequency band that is the 850-MHz band and frequency band B corresponds to the second resonance frequency band that is the 900-MHz band. In the third-generation mobile communication system (3G), the transmission frequency band is defined in the range of 824 to 849 MHz and the reception frequency band is defined in the range of 869 to 894 MHz in the 850-MHz band and the transmission frequency band is defined in the range of 880 to 915 MHz and the reception frequency band is defined in the range of 925 to 960 MHz in the 900-MHz band. In FIG. 3, for easy understanding, the reception frequency band of the frequency band A and the transmission frequency band of frequency band B are shown without overlapping each other. The switch circuit 2 switches the resonance frequency bands of the antenna 1 between the two resonance frequency bands (frequency bands A, B).

The resonance frequency bands switched by the switch circuit 2 are not limited to the above frequency bands. For example, it is possible to switch the resonance frequency bands between the 700-MHz band used in the Long Term Evolution (LTE) standard developed in the United States and the 850-MHz band used in the third-generation (3G) mobile communication system.

The antenna 1 is configured to cause the frequency ranges covered by the antenna elements 1a, 1b to be overlapped. Specifically, the antenna 1 is configured to transmit and receive a radio frequency signal of one (for example, frequency band B) of the resonance frequency bands even in a period in which the other resonance frequency band (for example, frequency band A) is selected by the switch circuit 2. For example, the antenna 1 is configured to have a gain (antenna efficiency) of at least −15 dB, which is obtained in one of the resonance frequency bands in a period in which the other resonance frequency band is selected.

Next, the operation principle of the antenna frequency control operation performed by the computer 10 is explained with reference to FIG. 4.

The antenna frequency control operation performed by the computer 10 is controlled by an antenna control utility 201 that is software. The antenna control utility 201 is one of utility programs executed under OS control.

Like the antenna control utility 201, each of an application programming interface (API) 211, driver 212 and host controller interface (HCI) 213 shown in FIG. 4 is a program executed under OS control. The driver 212 is a program to control the wireless communication module 124 and the API 211 is a program to provide an interface that controls the wireless communication module 124 that is hardware via the driver 212 based on software. Further, the HCI 213 is a program to provide an interface that controls various hardwares including the EC/KBC 125 via the BIOS 120 based on software.

The antenna control utility 201 manages a channel/frequency band correspondence table 251 by use of a storage area of the main memory 113 and the HDD 121. The channel/frequency band correspondence table 251 is a table holding information which indicates that each of the channels used by the wireless communication module 124 belongs to frequency band A or B, that is, the correspondence relationship between the channel numbers and the frequency bands.

The driver 212 that controls the wireless communication module 124 normally includes a function of acquiring the number of a channel that is now used from the wireless communication module 124. So the antenna control utility 201 periodically performs a polling process of acquiring the number (usage channel number) of a channel that is now used from the wireless communication module 124 (via the API 211, driver 212). The period of polling is set to a value that substantially does not obstruct the wireless communication operation.

The antenna control utility 201 that has acquired the usage channel number by the polling operation confirms that the channel number belongs to which one of frequency bands A and B with reference to the channel/frequency band correspondence table 251. That is, the wireless communication module 124 confirms the frequency band now used.

Further, the antenna control utility 201 stores which one of frequency bands A and B is now selected, that is, a state in which the antenna 1 mainly covers which one of frequency bands A and B. The antenna control utility 201 determines whether or not the selected frequency band stored therein coincides with the frequency band now used by the wireless communication module 124.

As described above, the signal line 4b used to supply a control signal to the switch circuit 2 is lead out from the EC/KBC 125 (not from the wireless communication module 124). Therefore, if the selected frequency band does not coincide with the frequency band now used by the wireless communication module 124, the antenna control utility 201 instructs the EC/KBC 125 (via the HCI 213, BIOS 120) to output a control signal that causes the switch circuit 2 to switch the frequency bands of the antenna 1.

As a result, the resonance frequency band of the antenna 1 is adaptively controlled according to the wireless communication now performed by the wireless communication module 124. Since the antenna control utility 201 that is software acquires a usage channel number of the wireless communication module 124 and determines whether the present state of the antenna 1 is good or not to control the resonance frequency band of the antenna 1, that is, since the resonance frequency band of the antenna 1 is controlled irrespective of the wireless communication module 124, it becomes unnecessary to additionally provide a function to the wireless communication module 124.

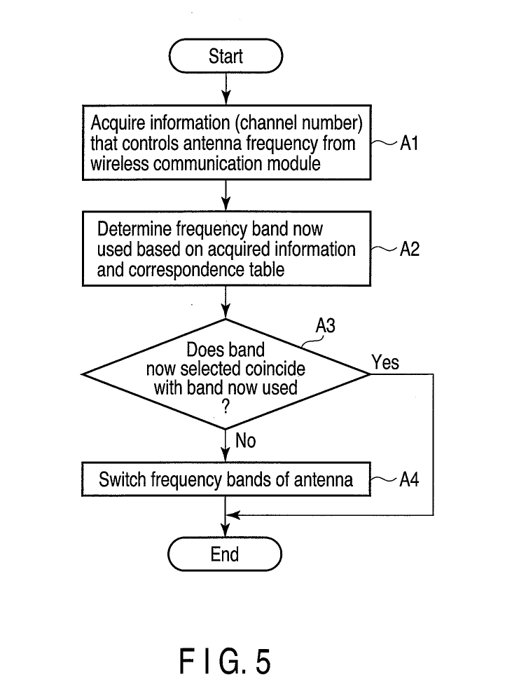

FIG. 5 is an exemplary flowchart for illustrating the operation procedure of the antenna frequency control operation performed by the computer 10.

First, the antenna control utility 201 performs a polling operation to acquire a usage channel number from the wireless communication module 124 (block A1). When acquiring the usage channel number, the antenna control utility 201 determines the frequency band now used by the wireless communication module 124 with reference to the channel/frequency band correspondence table 251 (block A2).

The antenna control utility 201 checks whether or not the frequency band selected by the antenna 1 coincides with the frequency band now used by the wireless communication module 124 (block A3). Then, if the frequency bands do not coincide with each other (NO in block A3), switching of the frequency band of the antenna 1 by the switch circuit 2 is performed and controlled (block A4).

In this case, an example in which the antenna control utility 201 checks whether the present state of the antenna 1 is good or not to control the resonance frequency band of the antenna 1 based on the usage channel number acquired from the wireless communication module 124 is explained. However, the embodiment is not limited to this case and, for example, a modification of separating the function of checking whether the present state of the antenna 1 is good or not to control the resonance frequency band of the antenna 1 from the antenna control utility 201 and mounting the function on the BIOS 120 or EC/KBC 125 can be included in an application range of this embodiment.

For example, the antenna control utility 201 has mounted thereon only a function of determining the frequency band now used by the wireless communication module 124 based on the usage channel number acquired from the wireless communication module 124 and notifying the frequency band to the BIOS 120. Then, the BIOS 120 or EC/KBC 125 stores the present state of the antenna 1 and determines whether the frequency bands of the antenna 1 are switched or not based on the notified frequency band. With the above configuration, the resonance frequency band of the antenna 1 can be controlled irrespective of the wireless communication module 124.

### Second Embodiment

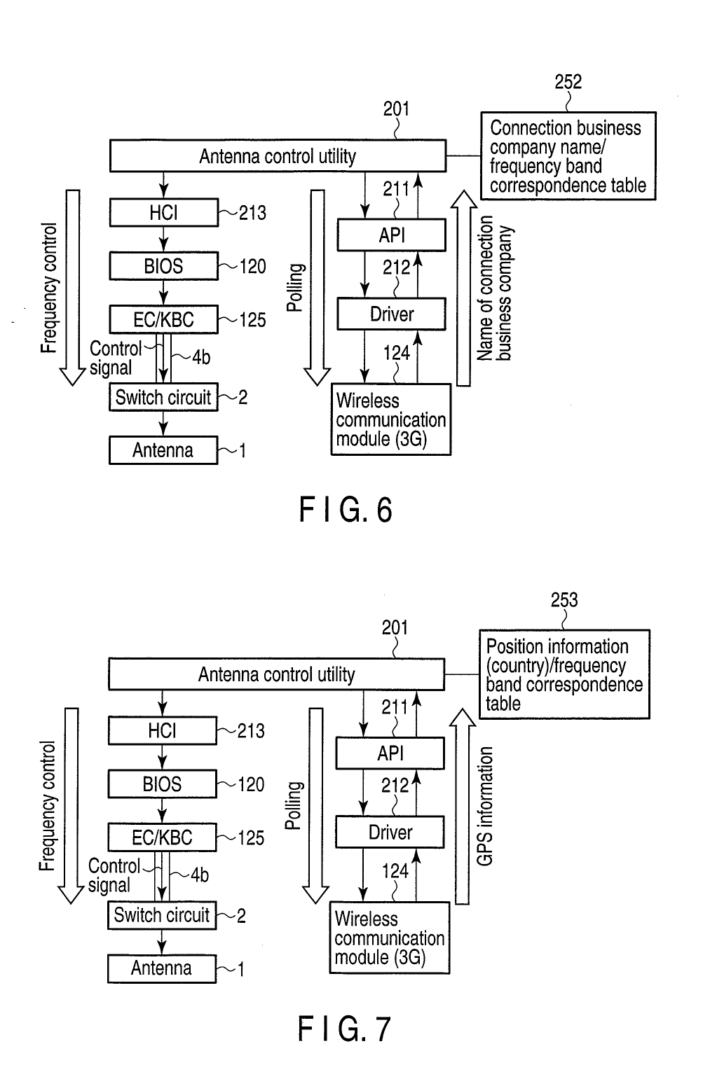

Next, a second embodiment is explained. FIG. 6 is an exemplary diagram for illustrating the operation principle of the antenna frequency control operation in the second embodiment.

In this example, it is assumed that the user of a computer 10 connects the computer 10 to Internet by use of a mobile telephone network. It is common practice for a wireless communication module 124 to support a function of acquiring information (the name of a connection business company) indicating a connection business company from a to-be-connected base station when a connection to the base station that forms a service area of the mobile telephone network is made. The area where the computer 10 is used is made clear based on the name of the connection business company. Further, since the frequency bands used are different depending on the areas, the frequency band to be selected by the antenna 1 can be specified (based on the name of the connection business company).

Therefore, in the second embodiment, an antenna control utility 201 periodically performs a polling operation for acquiring the name of the connection business company (instead of the “usage channel number” in the first embodiment) from the wireless communication module 124. Further, the antenna control utility 201 in the second embodiment manages a connection business company name/frequency band correspondence table 252 (instead of the “channel/frequency band correspondence table 251” in the first embodiment) that is a table holding the correspondence relationship between the names of the connection business companies and the frequency bands.

Each time the name of the connection business company is acquired, the antenna control utility 201 confirms the frequency band now used by the wireless communication module 124 with reference to the connection business company name/frequency band correspondence table 252. As explained in the first embodiment, since the antenna control utility 201 stores which one of frequency bands A and B is now selected, it determines whether or not the stored and selected frequency band coincides with the frequency band now used by the wireless communication module 124. Then, if the frequency bands do not coincide with each other, the antenna control utility 201 instructs the EC/KBC 125 (via the HCI 213, BIOS 120) to output a control signal that causes the switch circuit 2 to switch the frequency bands of the antenna 1.

That is, also, in the second embodiment, the antenna control utility 201 that is software acquires the name of the connection business company from the wireless communication module 124 and determines whether the present state of the antenna 1 is good or not to control the resonance frequency band of the antenna 1. Like the first embodiment described above, since the resonance frequency band of the antenna 1 is controlled irrespective of the wireless communication module 124, it becomes unnecessary to additionally provide a function to the wireless communication module 124.

### Third Embodiment

Next, a third embodiment is explained. FIG. 7 is an exemplary diagram for illustrating the operation principle of the antenna frequency control operation in the third embodiment.

Recently, it is common practice for a wireless communication module 124 to support a global positioning system (GPS) function. Information (GPS information) indicating a position including a country, for example, can be acquired from the wireless communication module 124 that supports the GPS function. If an area where the computer 10 is used is known, a frequency band to be selected by an antenna 1 can be specified as explained in the second embodiment. Particularly, there is a strong possibility that frequency bands used in the frequency band of 1 GHz or less can be distinguished depending on a country.

Therefore, in the third embodiment, an antenna control utility 201 periodically performs a polling process of acquiring GPS information from the wireless communication module 124. Further, the antenna control utility 201 of the third embodiment manages a position information/frequency band correspondence table 253 that is a table holding the correspondence relationship between the position information items and the frequency bands.

Each time GPS information is acquired, the antenna control utility 201 confirms the frequency band now used by the wireless communication module 124 with reference to the position information/frequency band correspondence table 253. As explained in the first embodiment, since the antenna control utility 201 stores which one of frequency bands A and B is now selected, it determines whether or not the stored and selected frequency band coincides with the frequency band now used by the wireless communication module 124. Then, if the frequency bands do not coincide with each other, the antenna control utility 201 instructs the EC/KBC 125 (via the HCI 213, BIOS 120) to output a control signal that causes the switch circuit 2 to switch the frequency bands of the antenna 1.

That is, also, in the third embodiment, the antenna control utility 201 that is software acquires GPS information from the wireless communication module 124 and determines whether the present state of the antenna 1 is good or not to control the resonance frequency band of the antenna 1. Like the first embodiment described before, since the resonance frequency band of the antenna 1 is controlled irrespective of the wireless communication module 124, it becomes unnecessary to additionally provide a function to the wireless communication module 124.

In the above explanation, a case wherein the 3G wireless communication module is used as the wireless communication module is shown as an example, but the configuration of the embodiment can be applied to any type of wireless communication system. Further, a case wherein the configuration of the embodiment is applied to the mobile computer is explained as an example, but the configuration of the embodiment can be applied to a mobile telephone, PDA and the like, for example.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
an antenna;
a switch configured to switch a resonance frequency band of the antenna between a first resonance frequency band and a second resonance frequency band;
a wireless communication processor configured to execute wireless communication by use of the first resonance frequency band and wireless communication by use of the second resonance frequency band and to provide status information indicating an execution state of wireless communication; and
a resonance frequency controller configured to acquire the status information from the wireless communication processor and control the switch in order to set the resonance frequency band of the antenna to the first resonance frequency band or the second resonance frequency band, based on the acquired status information.

2. The apparatus of claim 1, wherein the resonance frequency controller is configured to determine whether the first resonance frequency band or the second resonance frequency band is to be used based on the status information, and to control the switch to set the resonance frequency band of the antenna to the determined resonance frequency band.

3. The apparatus of claim 1, wherein the status information comprises a channel number used by the wireless communication processor.

4. The apparatus of claim 3, further comprising a correspondence module having stored thereon a correspondence table configured to store correspondence table data indicating a correspondence relationship between channel numbers and resonance frequency bands,
wherein the resonance frequency controller is configured to determine whether the first resonance frequency band or the second resonance frequency band is to be used based on the channel number with reference to the correspondence table data.

5. The apparatus of claim 1, wherein the status information comprises information regarding a wireless service provider associated with a base station obtained when the wireless communication processor is connected to the base station.

6. The apparatus of claim 5, further comprising a correspondence module having stored thereon a correspondence table configured to store correspondence table data indicating a correspondence relationship between connection business company information items and resonance frequency bands,
wherein the resonance frequency controller is configured to determine whether the first resonance frequency band or the second resonance frequency band is to be used based on the wireless service provider information with reference to the correspondence table data.

7. The apparatus of claim 1, wherein the status information comprises global positioning system (GPS) information.

8. The apparatus of claim 7, further comprising a correspondence module having stored thereon a correspondence table configured to store correspondence table data indicating a correspondence relationship between areas and resonance frequency bands,
wherein the resonance frequency controller is configured to determine whether the first resonance frequency band or the second resonance frequency band is to be used based on GPS information with reference to the correspondence table data.

9. The apparatus of claim 1, wherein the antenna is configured to have an efficiency of at least −15 dB in one of the resonance frequency bands when the other resonance frequency band is used.

10. An information processing apparatus comprising:
an antenna configured to switch resonance frequency bands;
a first controller configured to control execution of wireless communication by use of the antenna;
a processor configured to execute software that acquires an execution state of wireless communication from the first controller and controls switching of the resonance frequency bands of the antenna; and
a second controller configured to output a control signal used to switch the resonance frequency bands of the antenna under control of the software.

11. An antenna frequency control method comprising:
acquiring status information from a wireless communication processor configured to execute wireless communication, the status information indicating an execution state of wireless communication by the wireless communication processor;
determining whether a first resonance frequency band or a second resonance frequency band is to be used based on the acquired status information; and
controlling a switch to set a resonance frequency band of an antenna to the determined resonance frequency band.
